(19) United States
(12) Patent Application Publication
(10) Pub. No.: US 2018/0027596 A1
(43) Pub. Date: Jan. 25, 2018

(54) Method and Apparatus for Allocating Cell Radio Network Temporary Identifier and Communication System

(71) Applicant: FUJITSU LIMITED, Kawasaki-shi (JP)

(72) Inventors: Hua ZHOU, Beijing (CN); Lianhai WU, Beijing (CN); Haibo XU, Beijing (CN)

(73) Assignee: FUJITSU LIMITED, Kawasaki-shi (JP)

(21) Appl. No.: 15/723,383

(22) Filed: Oct. 3, 2017

Related U.S. Application Data
(63) Continuation of application No. PCT/CN2015/076278, filed on Apr. 10, 2015.

(51) Int. Cl. H04W 74/08; H04W 72/04

(52) U.S. Cl. CPC H04W 74/0866; H04W 72/044; H04W 72/0406; H04W 88/02

(57) ABSTRACT

A method and apparatus for allocating C-RNTI and a communication system. The method includes: generating, by a base station, an expanded C-RNTI for a user equipment, a length of the expanded C-RNTI being greater than 16 bits; and transmitting the expanded C-RNTI to the user equipment. Thereby, a structure of the C-RNTI may be enhanced, and a problem of allocation collision of C-RNTIs in case of a large number of carrier aggregation may be effectively eliminated.

### CROSS REFERENCE TO RELATED APPLICATIONS

This application is a continuation application of International Application PCT/CN2015/076278 filed on Apr. 10, 2015, the entire contents of which are incorporated herein by reference.

### TECHNICAL FIELD

This disclosure relates to the field of communication technologies, and in particular to a method and an apparatus for allocating a cell radio network temporary identifier (C-RNTI) and a communication system.

### BACKGROUND

In recent years, wireless communication technologies have developed rapidly, 3GPP standardization develops to Rel. 13, and key technologies cover wide configuration of small cells, carrier aggregation (CA), 3D multi-antenna technology (such as multiple input multiple output (MIMO)), and LTE enabling at an unlicensed band (such as licensed-assisted-access), etc.

Especially the CA technology, in the existing 3GPP standards, a transmission bandwidth of maximum 100 MHz may be achieved by multiple carriers (currently, at most 5 carriers are supported in downlink in 3GPP LTE Rel. 12), thereby effectively improving a transmission rate. And a user equipment (UE) may determine how many carriers may be used at the same time for transmission according to an ability of itself.

A C-RNTI is an identity code that is allocated when a user equipment successfully accesses to a network and used for uniquely identifying the user equipment, which is a sequence of a length of 16 bits in the current standard system. The C-RNTI is used to dynamically schedule unicast transmission or random access. According to the existing 3GPP TS36.321 standard, only a part of the 16-bit sequence of RNTI (such as 0001-003C and 003D-FFF3) is used for the C-RNTI allocation, and others shall be allocated for other RNTIs (such as M-RNTI, P-RNTI, and SI-RNTI, etc.).

In the Rel.10/11 standard system, the LTE-A system may have already supported a scenario of multiple component carriers (CCs). FIG. 1 is a schematic diagram of using carrier aggregation, in which a case where multiple small cells under coverage of a macro cell use multiple CCs is shown; and FIG. 2 is another schematic diagram for using carrier aggregation, in which a case where serving ranges of multiple small cells are not under coverage of a macro cell, and the multiple small cells may use multiple CCs, is shown.

It is specified in the existing standard TS36.321 that when a user equipment is configured with multiple CCs, C-RNTIs in all the CCs are identical, with a case of dual connectivity being not taken into account here.

FIG. 3 is a schematic diagram of a principle of C-RNTI allocation. For the sake of easy understanding, an example is given in FIG. 3 to explain the principle of C-RNTI allocation. As shown in FIG. 3, it is assumed that the system may aggregate at most 5 CCs. Taking UE 1 as an example, a primary component carrier (PCC) of UE 1 is CC 1, and other secondary component carriers (SCCs) are CC 2, CC 3, CC 4 and CC 5. A C-RNTI allocated by the base station for UE 1 is C-RNTI 1, the C-RNTI 1 being applicable to transmission of all the CCs of UE 1.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that with rapid development of intelligent terminals, a demand for continuous expanding the number of carrier aggregation in the future is increasing. For example, a carrier aggregation technology of how to support up to 32 carriers has been taken into account in 3GPP Rel. 13. With the increase of the number of carrier aggregation, the number of user equipment that may be served for will also be correspondingly increasing, and C-RNTIs that are allocated when the UE accesses to the network may possibly be insufficient.

That is, when the number of carrier aggregation is very large, such as 32 carriers discussed in the progress of the LTE standards, if a principle “each user equipment has only one C-RNTI” in Rel. 10/11 is still followed, as the number of existing C-RNTIs of 16 bits is limited, it cannot be ensured that different user equipments being allocated with different C-RNTIs, hence, correct transmission of subsequent channels, such as a physical downlink control channel (PDCCH), can also not be ensured. Therefore, a new structure and allocation method for a C-RNTI need to be designed.

Embodiments of this disclosure provide a method and an apparatus for allocating a C-RNTI and a communication system, in which a structure of an existing C-RNTI is enhanced, and which are expected to effectively eliminate a problem of allocation collision of C-RNTIs in case of a large number of carrier aggregation.

According to a first aspect of the embodiments of this disclosure, there is provided a method for allocating a C-RNTI, applicable to a base station of a multicarrier aggregation system, the method includes:

generating an expanded C-RNTI for a user equipment, a length of the expanded C-RNTI being greater than 16 bits; and

transmitting the expanded C-RNTI to the user equipment.

According to a second aspect of the embodiments of this disclosure, there is provided an apparatus for allocating a C-RNTI, configured in a base station of a multicarrier aggregation system, the apparatus includes:

an expanding unit configured to generate an expanded C-RNTI for a user equipment, a length of the expanded C-RNTI being greater than 16 bits; and

a transmitting unit configured to transmit the expanded C-RNTI to the user equipment.

According to a third aspect of the embodiments of this disclosure, there is provided a method for allocating a C-RNTI, applicable to a user equipment of a multicarrier aggregation system, the method includes:

receiving an expanded C-RNTI transmitted by a base station, a length of the expanded C-RNTI being greater than 16 bits; and

determining the expanded C-RNTI as a current C-RNTI.

According to a fourth aspect of the embodiments of this disclosure, there is provided an apparatus for allocating a C-RNTI, configured in a user equipment of a multicarrier aggregation system, the apparatus includes:

a receiving unit configured to receive an expanded C-RNTI transmitted by a base station, a length of the expanded C-RNTI being greater than 16 bits; and

an identification determining unit configured to determine the expanded C-RNTI as a current C-RNTI.

According to a fifth aspect of the embodiments of this disclosure, there is provided a communication system, including:

a base station configured to generate and transmit an expanded C-RNTI, a length of the expanded C-RNTI being greater than 16 bits; and

a user equipment configured to receive the expanded C-RNTI transmitted by the base station.

According to another aspect of the embodiments of this disclosure, there is provided a computer readable program code, which, when executed in a base station, will cause a computer unit to carry out the method for allocating a C-RNTI as described above in the base station.

According to a further aspect of the embodiments of this disclosure, there is provided a computer readable medium, including a computer readable program code, which will cause a computer unit to carry out the method for allocating a C-RNTI as described above in a base station.

According to still another aspect of the embodiments of this disclosure, there is provided a computer readable program code, which, when executed in a UE, will cause a computer unit to carry out the method for allocating a C-RNTI as described above in the UE.

According to a further aspect of the embodiments of this disclosure, there is provided a computer readable medium, including a computer readable program code, which will cause a computer unit to carry out the method for allocating a C-RNTI as described above in a UE.

An advantage of the embodiments of this disclosure exists in that by generating an expanded C-RNTI of a length greater than 16 bits, a structure of the C-RNTI may be enhanced, and a problem of allocation collision of C-RNTIs in case of a large number of carrier aggregation may be effectively eliminated.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of using carrier aggregation;

FIG. 2 is another schematic diagram of using carrier aggregation;

FIG. 3 is a schematic diagram of a principle of C-RNTI allocation;

FIG. 4 is a flowchart of the method for allocating a C-RNTI of Embodiment 1 of this disclosure;

FIG. 5 is a schematic diagram of a C-RNTI containing a cell group index of Embodiment 1 of this disclosure;

FIG. 6 is a schematic diagram of a CC group of Embodiment 1 of this disclosure;

FIG. 7 is another flowchart of the method for allocating a C-RNTI of Embodiment 1 of this disclosure;

FIG. 8 is a further flowchart of the method for allocating a C-RNTI of Embodiment 1 of this disclosure;

FIG. 9 is a schematic diagram of an expanded C-RNTI of Embodiment 1 of this disclosure;

FIG. 10 is a schematic diagram of a 20-bit C-RNTI commonly used in multiple CCs of Embodiment 1 of this disclosure;

FIG. 11 is a flowchart of the method for allocating a C-RNTI of Embodiment 2 of this disclosure;

FIG. 12 is another flowchart of the method for allocating a C-RNTI of Embodiment 2 of this disclosure;

FIG. 13 is a schematic diagram of the apparatus for allocating a C-RNTI of Embodiment 3 of this disclosure;

FIG. 14 is another schematic diagram of the apparatus for allocating a C-RNTI of Embodiment 3 of this disclosure;

FIG. 15 is a schematic diagram of a structure of the base station of Embodiment 3 of this disclosure;

FIG. 16 is a schematic diagram of the apparatus for allocating a C-RNTI of Embodiment 4 of this disclosure;

FIG. 17 is another schematic diagram of the apparatus for allocating a C-RNTI of Embodiment 4 of this disclosure;

FIG. 18 is a schematic diagram of the user equipment of Embodiment 4 of this disclosure; and

FIG. 19 is a schematic diagram of the communication system of Embodiment 5 of this disclosure.

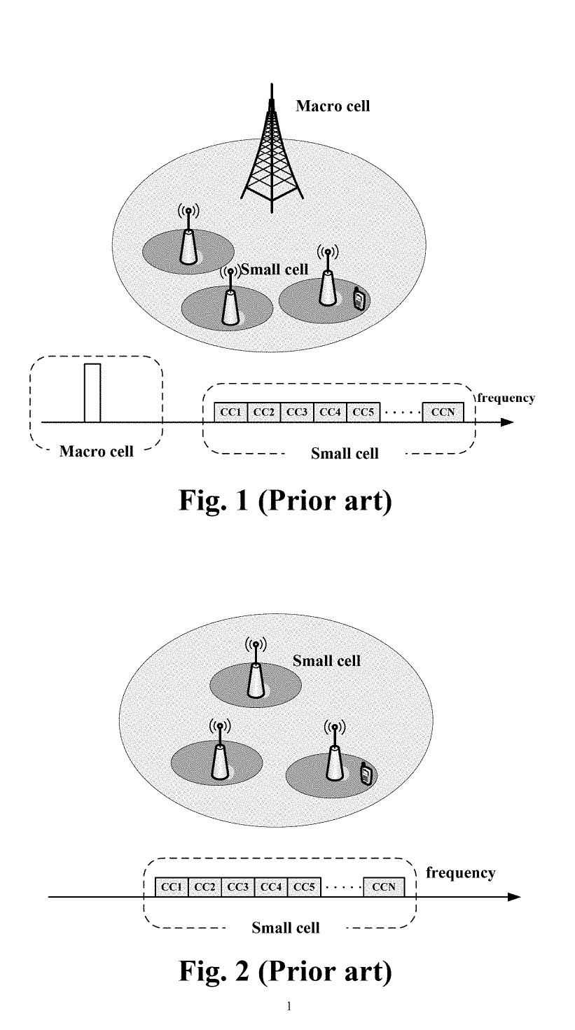

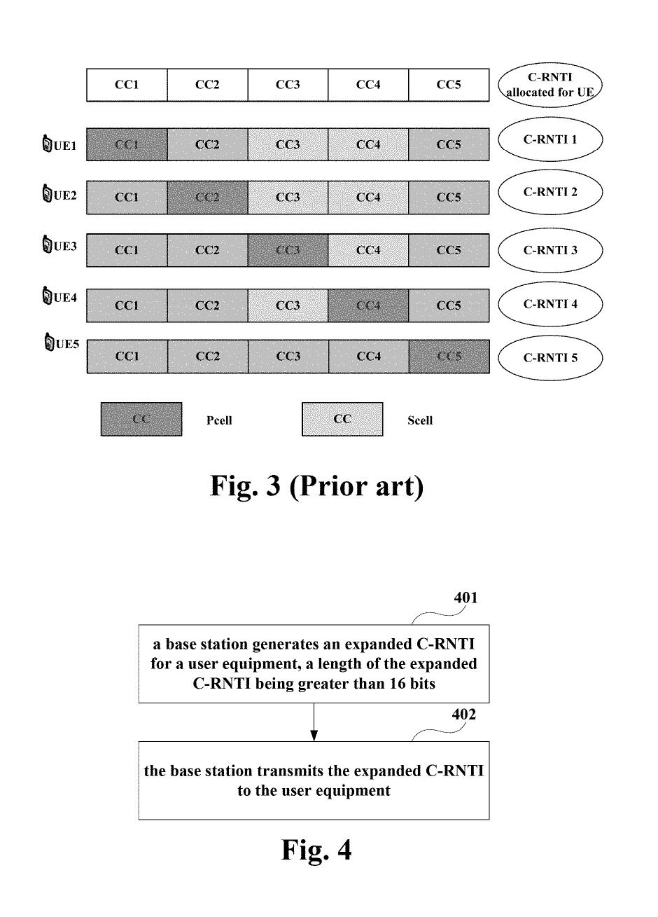

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the existing standards, a length of a C-RNTI is 16 bits, a system may aggregate at most 5 CCs, and when a user equipment is configured with multiple CCs, C-RNTI in all the CCs are identical. The C-RNTI is applicable to transmission of all the CCs of the UE.

For example, when the user equipment is needed to transmit a physical uplink control channel (PUCCH), a base station will use the C-RNTI to scramble cyclic redundancy check (CRC) of a PDCCH. For example, it is specified in existing standard TS36.212 that,

. . . the CRC parity bits are scrambled with the corresponding RNTI x_{rnti,0}, x_{rnti,1}, . . . x_{rnti,15}, where x_{rnti,0} corresponds to the MSB of the RNTI, to form the sequence of bits c₀, c₁, c₂, c₃, . . . , c_{B-1}. The relation between cₖ and bₖ is:

cₖ=bₖ for k=0,1,2, . . . ,A−1

cₖ=(bₖ+x_{rnti,k-A})mod 2 for k=A,A+1,A+2, . . . ,A+15.

Such a scrambling method shall be hereinafter referred to as an existing method, and the C-RNTI of 16 bits specified in the standards shall be referred to as an existing C-RNTI (which may also be referred to as a 16-bit C-RNTI). It can be seen therefrom that the 16-bit sequence of the existing C-RNTI is scrambled onto the 16-bit CRC of the PDCCH after modulo-2, so as to differentiate transmission of PDCCHs of different user equipments.

How to enhance a structure of a C-RNTI in case of a large number of carrier aggregation shall be described below.

### Embodiment 1

The embodiment of this disclosure provides a method for allocating a C-RNTI, applicable to a base station of a multicarrier aggregation system.

FIG. 4 is a flowchart of the method of the embodiment of this disclosure. As shown in FIG. 4, the method includes:

block 401: a base station generates an expanded C-RNTI for a user equipment, a length of the expanded C-RNTI being greater than 16 bits; and

block 402: the base station transmits the expanded C-RNTI to the user equipment.

In this embodiment, when the base station needs to allocate a C-RNTI for the user equipment, it generates the expanded C-RNTI for the user equipment. The length of the expanded C-RNTI is greater than 16 bits, such as 20 bits; however, this disclosure is not limited thereto, and the length may also be other numbers of bits.

In an implementation, the base station may divide multiple CCs into groups and generate group indices, and generate a 16-bit C-RNTI for the user equipment. The expanded C-RNTI is formed by a corresponding group index and the 16-bit C-RNTI.

That is, a graded C-RNTI bit sequence may be used. The bit sequence consists of two parts, one part is a cell group index (CGI), and the other part is the existing 16-bit C-RNTI. For example, the cell group index may be 4 bits, or 3 bits, or 2 bits, etc. And following description shall be given taking 4 bits as an example.

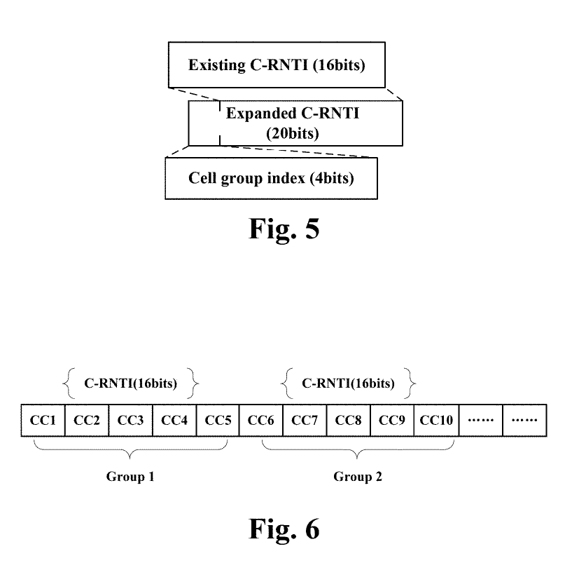

FIG. 5 is a schematic diagram of a C-RNTI containing a cell group index of the embodiment of this disclosure. As shown in FIG. 5, the expanded C-RNTI includes a 4-bit group index (i.e. CGI) and the 16-bit existing C-RNTI.

For example, the base station may allocate multiple CCs in cells into different cell groups according to a certain rule (such as a carrier frequency, and a bandwidth, etc.), the number of CCs in a cell group being 5, so as to be compatible with an existing system. Of course, this disclosure is not limited thereto; for example, other values may also be used. For example, a cell group where a CC is located may be represented by a CGI.

After the base station allocates the CGI, if a PCell of a user equipment belongs to a cell group, a current C-RNTI of the user equipment (i.e. an expanded C-RNTI) is an original 16-bit C-RNTI cascaded by the CGI.

Hence, as multiple CCs are divided into groups, it may be ensured that there exists no collision between C-RNTIs of different cell groups (CGI+16-bit original C-RNTI). For user equipments in a CC as the number of CCs is relatively small (such as 5), the problem of collision of C-RNTI allocation will also not be brought about, like that in an original system.

FIG. 6 is a schematic diagram of a CC group of the embodiment of this disclosure. As shown in FIG. 6, a relatively large number of CCs may be divided into multiple groups, and each group may correspond to a 16-bit C-RNTI sequence.

Of course, in order to ensure backward compatibility with original user equipment of the system, the base station may further determine whether to form a CC group according to the number of CCs to be aggregated, or other factors.

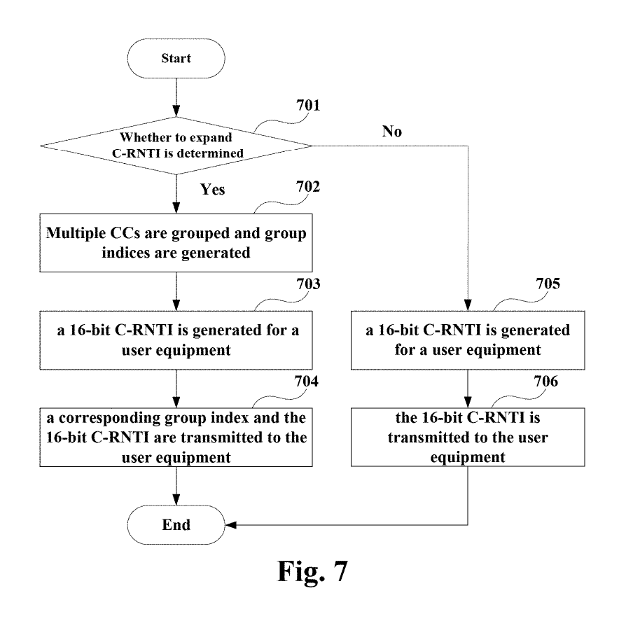

FIG. 7 is another flowchart of the method of the embodiment of this disclosure. As shown in FIG. 7, the method includes:

block 701: the base station determines whether to expand the C-RNTI, block 702 is executed when it is determined yes, and block 705 is executed when it is determined no;

for example, if the number of CCs is 5, like that in an existing standard, the base station may determine not to expand, or, although the number of CCs is greater than 5, the base station deems that division into groups is not needed according to other factors, the base station may determine not to expand;

block 702: multiple CCs are grouped and group indices are generated;

block 703: a 16-bit C-RNTI is generated for the user equipment;

block 704: a corresponding group index and the 16-bit C-RNTI are transmitted to the user equipment;

block 705: a 16-bit C-RNTI is generated for the user equipment; and

block 706: the 16-bit C-RNTI is transmitted to the user equipment.

In this implementation, when it is determined not to expand, a CGI of a specific sequence, such as a sequence in which all bits are 0, or a sequence in which all bits are 1, may be generated, indicating that the C-RNTI is still of 16 bits. In block 706, the CGI of the specific sequence may be transmitted to the user equipment.

In block 704, the base station may transmit the group index and the 16-bit C-RNTI via the same message, or may transmit the group index and the 16-bit C-RNTI via different messages. The messages may be radio resource control (RRC) messages, or media access control (MAC) layer messages.

In block 706, the base station may use an RRC message or an MAC message to transmit the 16-bit C-RNTI only, and may also use RRC messages or MAC messages to respectively transmit or use the same message to transmit the CGI of the specific sequence and the 16-bit C-RNTI.

After allocating the C-RNTI, the base station may use the C-RNTI allocated for the user equipment to scramble a PDCCH. Following description shall be given taking an expanded C-RNTI as an example, and a method in an existing standard may still be adopted for a C-RNTI that is not expanded.

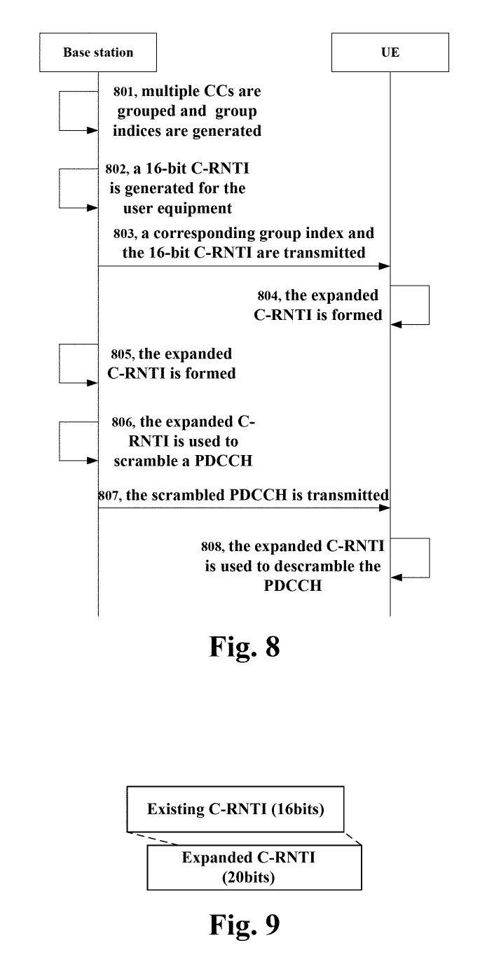

FIG. 8 is a further flowchart of the method of the embodiment of this disclosure. As shown in FIG. 8, the method includes:

801: the base station groups multiple CCs and generates group indices;

802: the base station generates a 16-bit C-RNTI for the user equipment;

803: the base station transmits a corresponding group index and the 16-bit C-RNTI to the user equipment;

804: the user equipment cascades the corresponding group index and the 16-bit C-RNTI to form the expanded C-RNTI; and

805: the base station cascades the corresponding group index and the 16-bit C-RNTI to form the expanded C-RNTI.

As shown in FIG. 8, the method may further include:

806: the base station uses the expanded C-RNTI to scramble a PDCCH;

807: the base station transmits the scrambled PDCCH to the user equipment; and

808: the user equipment uses the expanded C-RNTI to descramble the PDCCH.

In 806, if a bit length of the CRC is 20 bits, amendment may be made directed to the existing standard, and an amended scrambling method may be as follows:

. . . the CRC parity bits are scrambled with the corresponding RNTI x_{cgi,0}, x_{cgi,1}, x_{cgi,2}, x_{cgi,3}, x_{rnti,0}, x_{rnti,1}, . . . , x_{rnti,15}, where x_{cgi,0} corresponds to the MSB of the CGI, x_{rnti,0} corresponds to the MSB of the RNTI, to form the sequence of bits c₀, c₁, c₂, c₃, . . . , c_{B-1}. The relation between cₖ and bₖ is:

cₖ=bₖ for k=0,1,2, . . . ,A−1

cₖ=(bₖ+x_{cgi,k-A})mod 2 for k=A,A+1,A+2, . . . ,A+3.

cₖ=(bₖ+x_{rnti,k-A})mod 2 for k=A,A+1,A+2, . . . ,A+15.

In another implementation, different from the method for expanding the C-RNTI by adding the cell group indices in the above implementation, the 16-bit C-RNTI may be directly expanded; that is, the base station expands the length of the 16-bit C-RNTI into, for example, 20 bits, thereby forming the expanded C-RNTI.

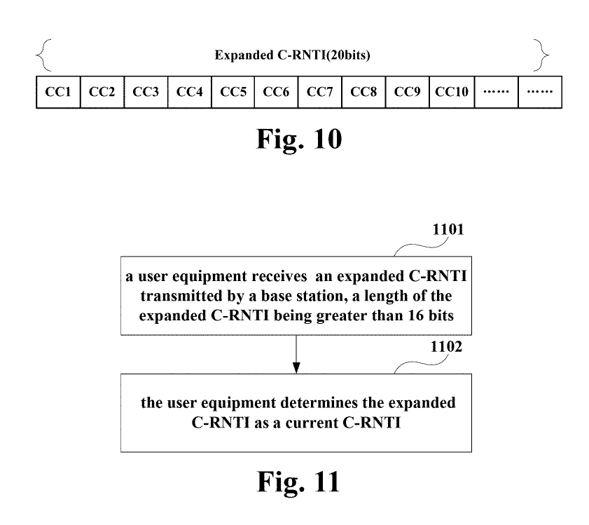

FIG. 9 is a schematic diagram of the expanded C-RNTI of the embodiment of this disclosure, and FIG. 10 is a schematic diagram of a 20-bit C-RNTI commonly used in multiple CCs of the embodiment of this disclosure. As shown in FIGS. 9 and 10, the expanded C-RNTI includes the 20-bit C-RNTI, and has no CGI information.

In this implementation, as the 16-bit C-RNTI is expanded into 20 bits, available C-RNTI resources are also expanded, thereby not only satisfying that C-RNTIs in all CCs of a user equipment are identical, but also ensuring that different user equipments may be allocated with uniquely-used C-RNTIs.

Correspondingly, for the PDCCH scrambling in the standards, if the 20-bit CRC is adopted, in this implementation, the method for scrambling by using the 20-bit C-RNTI may be amended into:

. . . the CRC parity bits are scrambled with the corresponding RNTI, x_{rnti,0}, x_{rnti,1}, . . . , x_{rnti,19}, where x_{rnti,0} corresponds to the MSB of the RNTI, to form the sequence of bits c₀, c₁, c₂, c₃, . . . , c_{B-1}. The relation between cₖ and bₖ is:

cₖ=bₖ for k=0,1,2, . . . ,A−1

cₖ=(bₖ+x_{rnti,k-A})mod 2 for k=A,A+1,A+2, . . . ,A+19.

In this implementation, other aspects, such as method for transmitting the C-RNTI and scrambling the PDCCH by the base station and a method for obtaining the C-RNTI by the user equipment, etc., may be similar to the previous implementations; for example, the 20-bit CGI+C-RNTI may be replaced with the 20-bit C-RNTI.

It can be seen from the above embodiment that by generating an expanded C-RNTI of a length greater than 16 bits, a structure of the C-RNTI may be enhanced, and a problem of allocation collision of C-RNTIs in case of a large number of carrier aggregation may be effectively eliminated.

### Embodiment 2

The embodiment of this disclosure provides a method for allocating a C-RNTI, applicable to a user equipment of a multicarrier aggregation system, with contents identical to those in Embodiment 1 being not going to be described herein any further.

FIG. 11 is a flowchart of the method of the embodiment of this disclosure. As shown in FIG. 11, the method includes:

block 1101: a user equipment receives an expanded C-RNTI transmitted by a base station, a length of the expanded C-RNTI being greater than 16 bits; and

block 1102: the user equipment determines the expanded C-RNTI as a current C-RNTI (i.e. a C-RNTI that is actually used by the user equipment).

In an implementation, the expanded C-RNTI may consist of a corresponding group index (i.e. a cell group index (CGI)) and a 16-bit C-RNTI.

For example, the user equipment may receive the group index and the 16-bit C-RNTI from the same message, or may receive the group index and the 16-bit C-RNTI from different messages, respectively. And these messages may be RRC messages, or MAC messages.

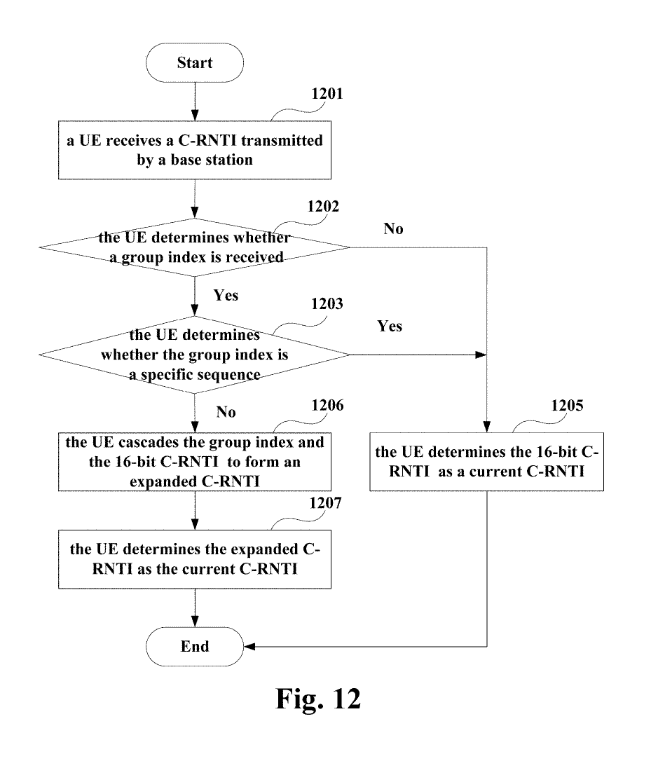

FIG. 12 is another flowchart of the method of the embodiment of this disclosure. As shown in FIG. 12, the method includes:

block 1201: the user equipment receives a C-RNTI transmitted by a base station, the C-RNTI being an existing 16-bit C-RNTI;

block 1202: the user equipment determines whether a group index is received, executing block 1203 if the group index is received, and executing block 1205 if the group index is not received;

block 1203: the user equipment determines whether the group index is a specific sequence, executing block 1205 if the group index is a specific sequence, and executing block 1206 if the group index is not a specific sequence;

block 1205: the user equipment determines the 16-bit C-RNTI as a current C-RNTI; block 1206: the user equipment cascades the group index and the 16-bit C-RNTI to form the expanded C-RNTI; and

block 1207: the user equipment determines the expanded C-RNTI as the current C-RNTI.

For example, the group index of the specific sequence includes a sequence in which all bits are 0, or a sequence in which all bits are 1. However, this disclosure is not limited thereto; for example, it may be a specific sequence in another form.

It should be noted that block 1202 and block 1203 do not necessarily exist at the same time, and only one of them may exist, which is depended on final configuration in a protocol.

In this implementation, after determining the current C-RNTI, the user equipment may use the current C-RNTI to descramble the PDCCH transmitted by the base station.

In another implementation, the expanded C-RNTI may be, for example, 20 bits in length, and may be formed by expanding a 16-bit C-RNTI. And furthermore, the user equipment may use the 20-bit C-RNTI to descramble the PDCCH transmitted by the base station.

It can be seen from the above embodiment that by generating an expanded C-RNTI of a length greater than 16 bits, a structure of the C-RNTI may be enhanced, and a problem of allocation collision of C-RNTIs in case of a large number of carrier aggregation may be effectively eliminated.

### Embodiment 3

The embodiment of this disclosure provides an apparatus for allocating a C-RNTI, configured in a base station of a multicarrier aggregation system, the embodiment of this disclosure corresponding to the method of Embodiment 1, with contents identical to those in Embodiment 1 being not going to be described herein any further.

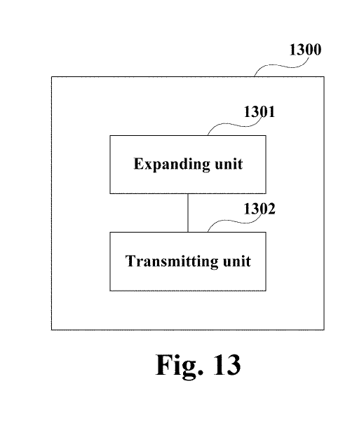

FIG. 13 is a schematic diagram of the apparatus of the embodiment of this disclosure. As shown in FIG. 13, the apparatus 1300 includes:

an expanding unit 1301 configured to generate an expanded C-RNTI for a user equipment, a length of the expanded C-RNTI being greater than 16 bits; and

a transmitting unit 1302 configured to transmit the expanded C-RNTI to the user equipment.

In an implementation, the expanded C-RNTI is formed by a corresponding group index (i.e. a cell group index (CGI)) and a 16-bit C-RNTI.

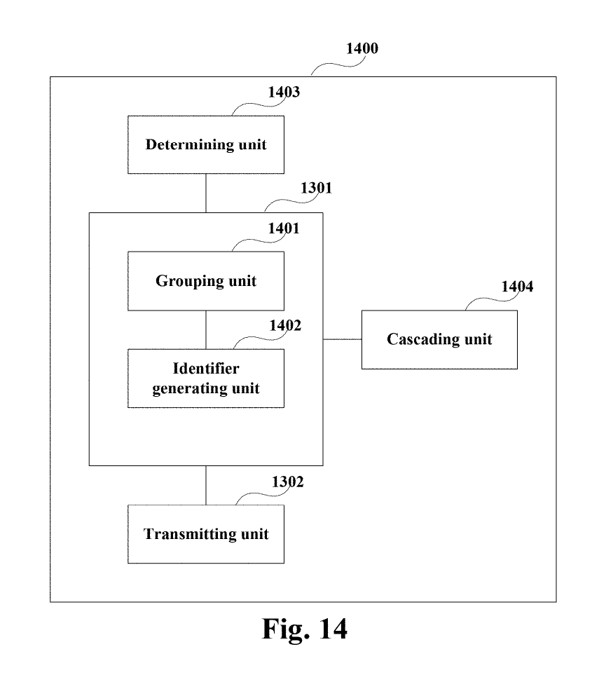

FIG. 14 is another schematic diagram of the apparatus of the embodiment of this disclosure. As shown in FIG. 14, the apparatus 1400 includes an expanding unit 1301 and a transmitting unit 1302, as described above.

As shown in FIG. 14, the expanding unit 1301 may include:

a grouping unit 1401 configured to group multiple component carriers and generate group indices; and

an identifier generating unit 1402 configured to generate a 16-bit C-RNTI for the user equipment; and the expanded C-RNTI is formed by a corresponding group index and the 16-bit C-RNTI.

In this embodiment, the transmitting unit 1302 may transmit the group index and the 16-bit C-RNTI via the same message, or may respectively transmit the group index and the 16-bit C-RNTI via different messages.

As shown in FIG. 14, the apparatus 1400 may further include:

a determining unit 1403 configured to determine whether to expand the C-RNTI. In this embodiment, the grouping unit 1401 may be configured not to generate the group index or be configured to generate a group index of a specific sequence when the determining unit 1403 determines not to expand the C-RNTI. For example, the specific sequence may include: a sequence in which all bits are 0 or a sequence in which all bits are 1.

As shown in FIG. 14, the apparatus 1400 may further include:

a cascading unit 1404 configured to cascade the corresponding group index and the 16-bit C-RNTI, so as to form the expanded C-RNTI.

In another implementation, the expanding unit 1301 may be configured to expand a length of the 16-bit C-RNTI into, for example, 20 bits.

The embodiment of this disclosure further provides a base station, configured with the above-described apparatus 1300 or apparatus 1400.

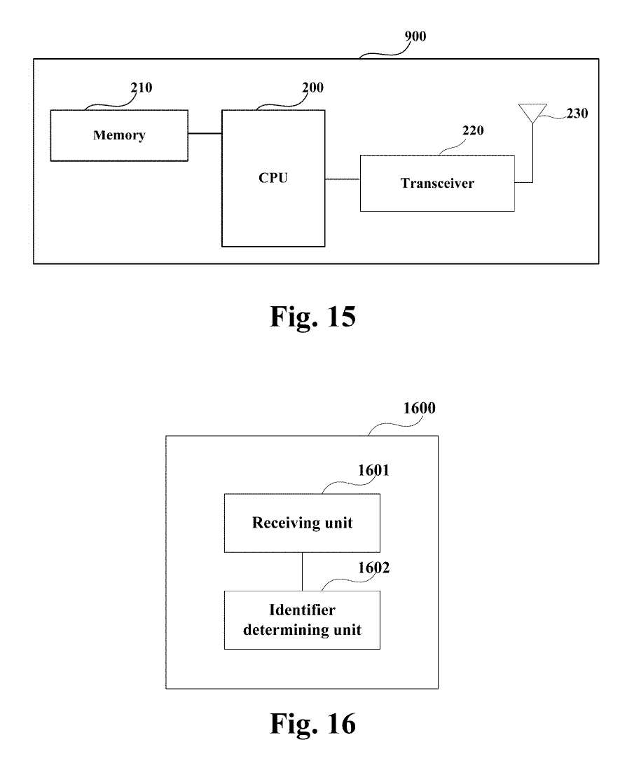

FIG. 15 is a schematic diagram of a structure of the base station of the embodiment of this disclosure. As shown in FIG. 15, the base station 1500 may include a central processing unit (CPU) 200 and a memory 210, the memory 210 being coupled to the central processing unit 200. The memory 210 may store various data, and furthermore, it may store a program for information processing, and execute the program under control of the central processing unit 200.

The base station 1500 may carry out the method for allocating a C-RNTI described in Embodiment 1. And the central processing unit 200 may be configured to carry out the functions of the apparatus 1300 or apparatus 1400, that is, the central processing unit 200 may be configured to perform the following control: generating an expanded C-RNTI for a user equipment, a length of the expanded C-RNTI being greater than 16 bits; and transmitting the expanded C-RNTI to the user equipment.

Furthermore, the base station 1500 may include a scrambling unit configured to use the expanded C-RNTI to scramble a PDCCH transmitted to the user equipment. For example, a C-RNTI obtained by cascading a corresponding group index and the 16-bit C-RNTI is used to scramble, or a 20-bit C-RNTI obtained by directly expanding the 16-bit C-RNTI is used to scramble.

Furthermore, as shown in FIG. 15, the base station 1500 may include a transceiver 220, and an antenna 230, etc. Functions of the above components are similar to those in the relevant art, and shall not be described herein any further. It should be noted that the base station 1500 does not necessarily include all the parts shown in FIG. 15, and furthermore, the base station 1500 may include parts not shown in FIG. 15, and the relevant art may be referred to.

It can be seen from the above embodiment that by generating an expanded C-RNTI of a length greater than 16 bits, a structure of the C-RNTI may be enhanced, and a problem of allocation collision of C-RNTIs in case of a large number of carrier aggregation may be effectively eliminated.

### Embodiment 4

The embodiment of this disclosure provides an apparatus for allocating a C-RNTI, configured in a user equipment of a multicarrier aggregation system, the embodiment of this disclosure corresponding to the method of Embodiment 2, with contents identical to those in Embodiment 2 being not going to be described herein any further.

FIG. 16 is a schematic diagram of the apparatus of the embodiment of this disclosure. As shown in FIG. 16, the apparatus 1600 includes:

a receiving unit 1601 configured to receive an expanded C-RNTI transmitted by a base station, a length of the expanded C-RNTI being greater than 16 bits; and

an identifier determining unit 1602 configured to determine the expanded C-RNTI as a current C-RNTI.

In an implementation, the expanded C-RNTI is formed by a corresponding group index and a 16-bit C-RNTI. The receiving unit 1601 may receive the group index and the 16-bit C-RNTI from the same message, or receive the group index and the 16-bit C-RNTI from different messages, respectively.

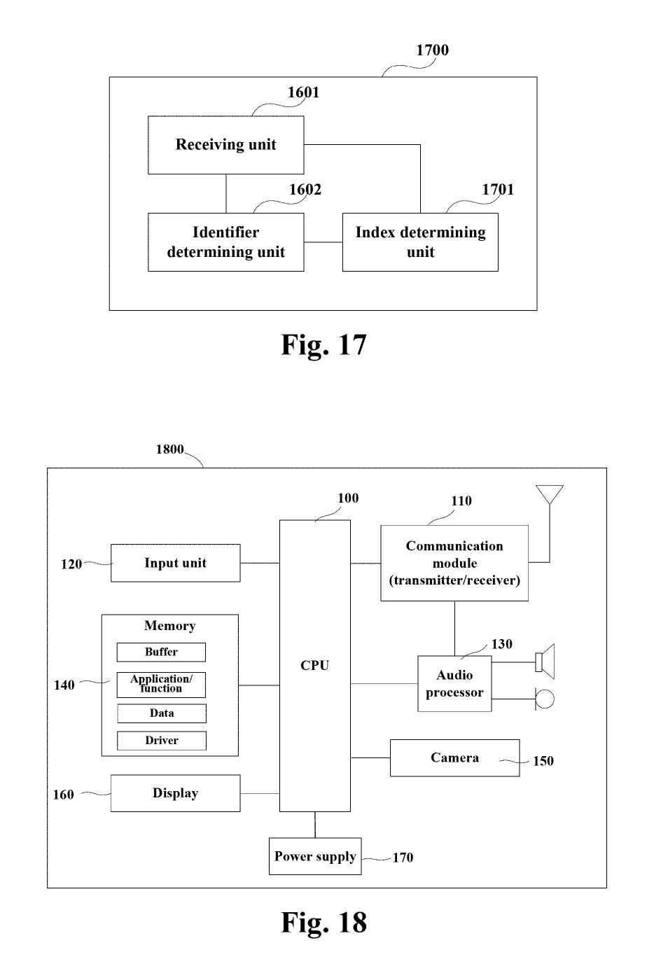

FIG. 17 is another schematic diagram of the apparatus of the embodiment of this disclosure. As shown in FIG. 17, the apparatus 1700 includes a receiving unit 1601 and an identification determining unit 1602, as described above.

As shown in FIG. 17, the apparatus 1700 may further include:

an index determining unit 1701 configured to determine whether the group index is received or whether the group index is a specific sequence;

and the identifier determining unit 1602 may further be configured to determine the 16-bit C-RNTI as the current C-RNTI when the group index is not received or the group index is a specific sequence; and cascade the group index and the 16-bit C-RNTI to form the expanded C-RNTI when the group index is received and the group index is not a specific sequence, and determine the expanded C-RNTI as the current C-RNTI.

For example, the specific sequence may include: a sequence in which all bits are 0 or a sequence in which all bits are 1.

In another implementation, the expanded C-RNTI is, for example, 20 bits in length.

The embodiment of this disclosure further provides a user equipment, configured with the above-described apparatus 1600 or apparatus 1700.

FIG. 18 is a schematic diagram of a structure of the user equipment of the embodiment of this disclosure. As shown in FIG. 18, the user equipment 1800 may include a central processing unit 100 and a memory 140, the memory 140 being coupled to the central processing unit 100. It should be noted that this figure is illustrative only, and other types of structures may also be used, so as to supplement or replace this structure and achieve a telecommunications function or other functions.

In an implementation, the functions of the apparatus 1600 or apparatus 1700 may be integrated into the central processing unit 100. For example, the central processing unit 100 may be configured to perform the following control: receiving an expanded C-RNTI transmitted by a base station, a length of the expanded C-RNTI being greater than 16 bits.

In another implementation, the apparatus 1600 or apparatus 1700 and the central processing unit 100 may be configured separately. For example, the apparatus 1600 or apparatus 1700 may be configured as a chip connected to the central processing unit 100, with its functions being realized under control of the central processing unit 100.

Furthermore, the user equipment 1800 may further include a descrambling unit configured to use the current C-RNTI to descramble a PDCCH transmitted by the base station. For example, a C-RNTI obtained by cascading a corresponding group index and the 16-bit C-RNTI is used to descramble, or a 20-bit C-RNTI obtained by directly expanding the 16-bit C-RNTI is used to descramble.

As shown in FIG. 18, the user equipment 1800 may further include a communication module 110, an input unit 120, an audio processor 130, a memory 140, a camera 150, a display 160 and a power supply 170. Functions of the above components are similar to those in the relevant art, and shall not be described herein any further. It should be noted that the user equipment 1800 does not necessarily include all the parts shown in FIG. 18, and furthermore, the user equipment 1800 may include parts not shown in FIG. 18, and the relevant art may be referred to.

It can be seen from the above embodiment that by generating an expanded C-RNTI of a length greater than 16 bits, a structure of the C-RNTI may be enhanced, and a problem of allocation collision of C-RNTIs in case of a large number of carrier aggregation may be effectively eliminated.

### Embodiment 5

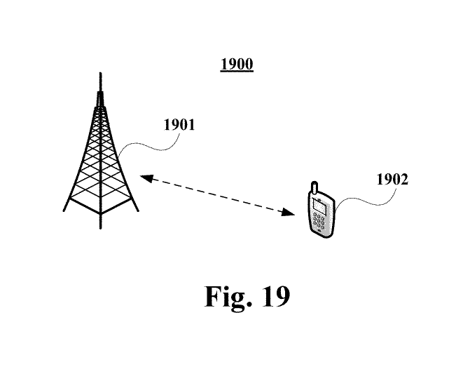

The embodiment of this disclosure provides a communication system, with contents identical to those in embodiments 1-4 being not going to be described herein any further. FIG. 19 is a schematic diagram of the communication system of the embodiment of this disclosure. As shown in FIG. 19, the communication system 1900 includes: a base station 1901 and a user equipment 1902.

The base station 1901 is configured to generate and transmit an expanded C-RNTI, a length of the expanded C-RNTI being greater than 16 bits; and the user equipment 1902 is configured to receive the expanded C-RNTI transmitted by the base station 1901.

In an implementation, the expanded C-RNTI consists of a corresponding group index and a 16-bit C-RNTI.

In another implementation, the expanded C-RNTI is, for example, 20 bits in length, and is formed by expanding a 16-bit C-RNTI.

An embodiment of the present disclosure provides a computer readable program code, which, when executed in a base station, will cause a computer unit to carry out the method for allocating a C-RNTI described in Embodiment 1 in the base station.

An embodiment of the present disclosure provides a computer readable medium, including a computer readable program code, which will cause a computer unit to carry out the method for allocating a C-RNTI described in Embodiment 1 in a base station.

An embodiment of the present disclosure provides a computer readable program code, which, when executed in a user equipment, will cause a computer unit to carry out the method for allocating a C-RNTI described in Embodiment 2 in the user equipment.

An embodiment of the present disclosure provides a computer readable medium, including a computer readable program code, which will cause a computer unit to carry out the method for allocating a C-RNTI described in Embodiment 2 in a user equipment.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communication combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An apparatus for allocating a cell radio network temporary identifier (C-RNTI), configured in a base station of a multicarrier aggregation system, the apparatus comprising:
an expanding unit configured to generate an expanded C-RNTI for a user equipment, a length of the expanded C-RNTI being greater than 16 bits; and
a transmitting unit configured to transmit the expanded C-RNTI to the user equipment.

2. The apparatus according to claim 1, wherein the expanding unit comprises:
a grouping unit configured to group multiple component carriers and generate group indices; and
an identifier generating unit configured to generate a 16-bit C-RNTI for the user equipment; wherein the expanded C-RNTI comprises a corresponding group index and the 16-bit C-RNTI.

3. The apparatus according to claim 2, wherein the transmitting unit is configured to transmit the group index and the 16-bit C-RNTI via a same message, or respectively transmit the group index and the 16-bit C-RNTI via different messages.

4. The apparatus according to claim 2, wherein the apparatus further comprises:
a determining unit configured to determine whether to expand the C-RNTI.

5. The apparatus according to claim 4, wherein the grouping unit is configured not to generate the group index or the grouping unit is configured to generate a specific sequence when the determining unit determines not to expand the C-RNTI.

6. The apparatus according to claim 5, wherein the specific sequence comprises: a sequence in which all bits are 0, or a sequence in which all bits are 1.

7. The apparatus according to claim 2, wherein the apparatus further comprises:
a cascading unit configured to cascade the corresponding group index and the 16-bit C-RNTI, to form the expanded C-RNTI.

8. The apparatus according to claim 1, wherein the expanding unit is configured to expand a length of a 16-bit C-RNTI into 20 bits, to generate the expanded C-RNTI.

9. An apparatus for allocating a cell radio network temporary identifier (C-RNTI), configured in a user equipment of a multicarrier aggregation system, the apparatus comprising:
a receiving unit configured to receive an expanded C-RNTI transmitted by a base station, a length of the expanded C-RNTI being greater than 16 bits; and
an identifier determining unit configured to determine the expanded C-RNTI as a current C-RNTI.

10. The apparatus according to claim 9, wherein the expanded C-RNTI comprises a corresponding group index and a 16-bit C-RNTI.

11. The apparatus according to claim 10, wherein the receiving unit is configured to receive the group index and the 16-bit C-RNTI from a same message, or respectively receive the group index and the 16-bit C-RNTI from different messages.

12. The apparatus according to claim 10, wherein the apparatus further comprises:
an index determining unit configured to determine whether the group index is received or whether the group index is a specific sequence;
and the identifier determining unit is further configured to determine the 16-bit C-RNTI as the current C-RNTI when the group index is not received or the group index is a specific sequence.

13. The apparatus according to claim 12, wherein the specific sequence comprises: a sequence in which all bits are 0, or a sequence in which all bits are 1.

14. The apparatus according to claim 9, wherein the expanded C-RNTI is 20 bits in length and is formed by expanding a 16-bit C-RNTI.

15. A communication system, comprising:
a base station configured to generate and transmit an expanded cell radio network temporary identifier (C-RNTI), a length of the expanded C-RNTI being greater than 16 bits; and
a user equipment configured to receive the expanded C-RNTI transmitted by the base station.

16. The communication system according to claim 15, wherein the expanded C-RNTI comprises a corresponding group index and a 16-bit C-RNTI.

17. The communication system according to claim 15, wherein the expanded C-RNTI is 20 bits in length and is formed by expanding a 16-bit C-RNTI.
